(19) United States
(12) Patent Application Publication
(10) Pub. No.: US 2024/0040238 A1
(43) Pub. Date: Feb. 1, 2024

(54) MOBILE TERMINAL, NON-TRANSITORY COMPUTER READABLE MEDIUM, AND IMAGING METHOD

(71) Applicant: FUJIFILM Business Innovation Corp., Tokyo (JP)

(72) Inventors: Yukari MOTOSUGI, Kanagawa (JP); Momoko FUJIWARA, Tokyo (JP); Ken SATO, Kanagawa (JP); Masaki KYOJIMA, Kanagawa (JP); Minoru OSHIMA, Kanagawa (JP)

(73) Assignee: FUJIFILM Business Innovation Corp., Tokyo (JP)

(21) Appl. No.: 18/306,598

(22) Filed: Apr. 25, 2023

(30) Foreign Application Priority Data
Jul. 27, 2022 (JP) 2022-119733

(51) Int. Cl. H04N 23/63

(52) U.S. Cl. CPC H04N 23/635

(57) ABSTRACT

A mobile terminal includes a light source, a camera, a display, and a processor configured to, when a comparison region of a target is imaged, display on the display a guide image at an angle of rotation responsive to information related to a positional relationship of the camera and the light source, the guide image being used to image the comparison region, with a relative position and posture of the light source, the camera, and the comparison region satisfying a specific relationship.

### CROSS-REFERENCE TO RELATED APPLICATIONS

This application is based on and claims priority under 35 USC 119 from Japanese Patent Application No. 2022-119733 filed Jul. 27, 2022.

### BACKGROUND

### (i) Technical Field

The present disclosure relates to a mobile terminal, a non-transitory computer readable medium, and an imaging method.

### (ii) Related Art

Japanese Patent No. 6206645 discloses a mobile terminal including a light source, a camera, a display and a controller. When a comparison region of a target having a satin pattern is imaged, the controller displays on a display a reference image used to capture the comparison image, in superimposition on a through-the-lens image in a manner such that a relative position and posture of the light source, the camera, and the comparison region satisfy a specific relationship. The controller uses a reference image for the mobile terminal of interest from among reference images of different mobile terminals that are used to control the positions and postures of the mobile terminals such that a comparison region of the target is imaged under the same imaging condition among the different mobile terminals. Images of the comparison region of the target are captured in advance under the same imaging condition (with identical illumination direction and identical captured image size) on mobile terminals that are different in terms of the layout of lights and camera viewing angle and the image capturing is performed according to the model of each mobile terminal. The controller retrieves an image responsive to the mobile terminal of interest out of the acquired images and displays that image as a reference image in superimposition on the through-the-lens image. A user performs an operation on the comparison region of an imaging target and the reference image on an imaging screen such that the comparison region and the reference image match each other in terms of direction, position, and size. This causes the relative position and posture of the light source and camera of the mobile terminal to be identical to the relative position and posture when the reference image has been captured. In this way, the comparison region of the target is imaged under the same imaging condition even when the mobile terminals are different in terms of the layout of the lights and viewing angle of the camera.

### SUMMARY

Aspects of non-limiting embodiments of the present disclosure relate to providing a technique that enables multiple different models of terminals to reproduce a predetermined relative position and posture without preparing, on a per terminal model basis, images that have been captured by imaging a comparison region at a relative position and posture of a predetermined light source, camera, and comparison region.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a mobile terminal including a light source, a camera, a display, and a processor configured to; when a comparison region of a target is imaged, display on the display a guide image at an angle of rotation responsive to information related to a positional relationship of the camera and the light source, the guide image being used to image the comparison region, with a relative position and posture of the light source, the camera, and the comparison region satisfying a specific relationship.

### BRIEF DESCRIPTION OF THE DRAWINGS

Exemplary embodiments of the present disclosure will be described in detail based on the following figures, wherein:

FIG. 1 illustrates a system configuration of a first exemplary embodiment;

FIG. 2 is a block diagram illustrating a comparison image capturing apparatus of the first exemplary embodiment;

FIGS. 3A and 3B are plan views of a target including a hologram region and a target of paper according to the first exemplary embodiment;

FIG. 4 illustrates an angle of rotation indicating the direction of a light source viewed from a camera in the first exemplary embodiment;

FIG. 5 illustrates a positional relationship of a light source, camera, and ink region according to the first embodiment when registration is performed;

FIG. 6 illustrates the positional relationship of the light source, camera, and ink region according to the first embodiment when comparison is performed;

FIG. 7 illustrates a guide image displayed on a mobile terminal of the first exemplary embodiment;

FIGS. 8A and 8B illustrate the guide image of the mobile terminal prior to rotation according to the first exemplary embodiment;

FIGS. 9A through 9C illustrate the guide image on a per model basis according to the first exemplary embodiment;

FIG. 10 is a flowchart illustrating a process of the first exemplary embodiment;

FIG. 11 illustrates a relationship of distances and an angle of a reflecting surface according to a second exemplary embodiment;

FIGS. 12A through 12C illustrate the guide image on a per model basis according to the second exemplary embodiment;

FIGS. 13A through 13C illustrate the guide image on a per model basis according to a third exemplary embodiment; and

FIG. 14 illustrates a system configuration of a modification of the exemplary embodiments.

### DETAILED DESCRIPTION

### First Exemplary Embodiment

Exemplary embodiments of the disclosure are described with reference to the drawings. An individual identification system is described below. The individual identification system captures a surface image of a target and identifies the target by comparing a registration image with a comparison image.

The individual identification system is a technique used to uniquely identify an authentic target. The individual identification system registers, in advance, part of a surface of an object, specifically an image as large as 0.1 mm to several mm, as information unique to the object and verifies that the object to be compared is the registered object. The information unique to the object is, for example, a random fine pattern. For example, the fine random pattern is a satin pattern. The satin patterns may include surfaced treated frosted glass, satin pattern resulting from surface treatment on a metal or synthetic resin (plastic), wrinkled pattern resulting from emboss processing, randomly weaved fibrous pattern, random fine dot pattern printed, and random particle distribution printed with ink containing photoluminescent particles. The satin patterns may further include a satin pattern that is formed unintentionally by chance and a satin pattern that is intentionally formed for identification or comparison. The satin pattern may be a random pattern that is difficult to form by controlling. The technique is a type of artifact metrics that optically read the random pattern and use the read random pattern as information.

Printing material having an uneven surface, such as hologram or paper, is used and an ink region containing dispersed metal particles printed on the printing material having the uneven surface is used as the random pattern.

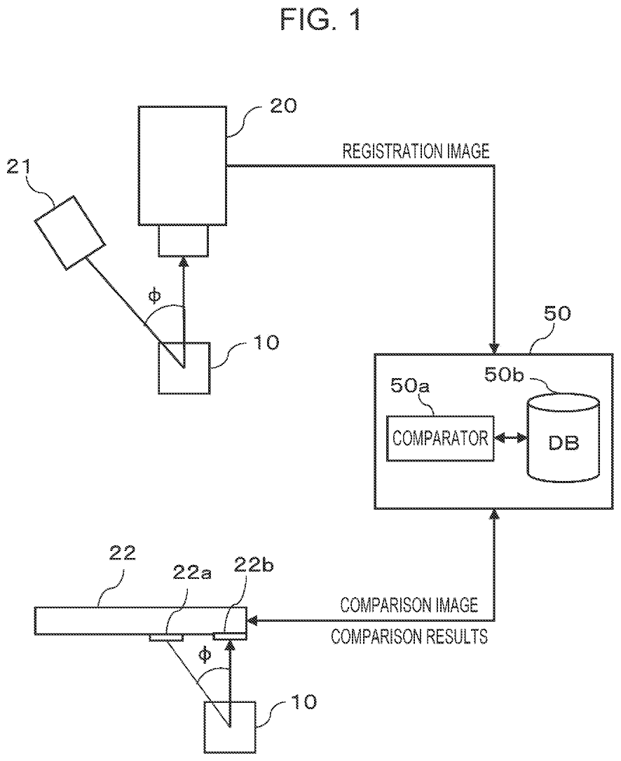

FIG. 1 illustrates a system configuration example of a system of the first exemplary embodiment. The system functions as a display control system and an individual identification system and includes a registration image capturing apparatus 20, comparison image capturing apparatus 22, and server computer 50. The registration image capturing apparatus 20 is connected to the server computer 50 via a communication network and the comparison image capturing apparatus 22 is connected to the server computer 50 via a communication network. The communication network may include a wired network, a wireless network, a public network, an exclusive network and/or the Internet.

A light source 21, such as a light-emitting diode, is disposed close to the registration image capturing apparatus 20 and irradiates the target 10 with light. The registration image capturing apparatus 20 captures light reflected from the target 10, thereby acquiring a registration image. The registration image capturing apparatus 20 and the light source 21 may be instruments dedicated for registration, for example, respectively a dedicated camera and a dedicated light installed in a plant.

An irradiation angle φ of irradiation light from the light source 21 is set to a constant angle. The acquired registration image is transmitted to the server computer 50 and stored on a registration database (DB) 50b in the server computer 50.

A mobile terminal, such as a smart phone carried by a user of the system, works as the comparison image capturing apparatus 22 and images the target 10. A light source 22a, such as an LED, on the smart phone, irradiates the target 10 with light and a camera 22b, mounted on the smart phone, captures light reflected from the target 10.

A processor in the comparison image capturing apparatus 22 extracts an ink region from the captured image by performing a series of operations on the captured image, and clips a comparison image as a comparison region from the ink region, and transmits the comparison image to the server computer 50.

The server computer 50 includes a comparator 50a and a registration image database (DB) 50b.

The registration image DB 50b includes a storage, such as a hard disk or a solid-state drive (SSD), and stores in an associated form a registration image and an identifier ID uniquely identifying the target 10.

The comparator 50a includes a processor and stores in an associated form on the registration image DB 50b the registration image received from the registration image capturing apparatus 20 and the ID of the target 10. The comparator 50a performs image comparison by comparing the comparison image received from the comparison image capturing apparatus 22 with the registration image stored on the registration image DB 50b and outputs comparison results to the comparison image capturing apparatus 22.

Specifically, the comparator 50a performs a comparison calculation on the comparison image by reading the registration image from the registration image DB 50b and calculates a degree of similarity of the images. The degree of similarity may be calculated using one of related-art algorithms. If the calculated degree of similarity, when compared with a threshold, is higher than the threshold, the two images are determined to match each other. If the calculated degree of similarity is not higher than the threshold, the two images are not determined to match each other. The comparator 50a transmits the comparison results to the comparison image capturing apparatus 22 via the communication network.

The image comparison is subject to rates of errors that are attributed to variations and quantization error in an input to image sensors of the registration image capturing apparatus 20 or the comparison image capturing apparatus 22. The error rates includes two rates, namely, a false rejection rate and false acceptance rate. The false rejection rate is a probability that something is determined as being false even though something is true and the false acceptance rate is a probability that something is determined as true even though something is false. The two rates are in a trade-off relationship in which one rate increases as the other rate decreases. The threshold is set such that a loss in a comparison determination of an application target is minimized.

Multiple registration images captured with the irradiation direction of light changed are registered on the registration image DB 50b in the server computer 50 and the comparison image is compared with each of the registration images. In this case, the irradiation direction of light is determined based on a luminance point detected from the comparison image or a luminance distribution of the comparison image and, from among the registration images, a registration image that is captured at the same irradiation direction as the irradiation direction identified from the comparison image may be used. If the luminance point is difficult to acquire from the comparison image, the irradiation direction of light may be determined using the luminance distribution of the comparison image.

According to the first exemplary embodiment, the registration image capturing apparatus 20 and light source 21 are instruments dedicated for registration. Alternatively, the registration image capturing apparatus 20 and light source 21 may be a mobile terminal, such as a smart phone used as the comparison image capturing apparatus 22. Specifically, the mobile terminal of the exemplary embodiments may be used not only as the comparison image capturing apparatus 22 but also as the registration image capturing apparatus 20. See below for further details.

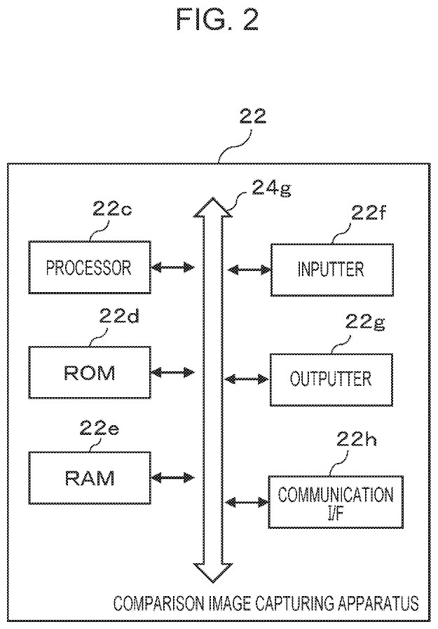

FIG. 2 is a block diagram illustrating the comparison image capturing apparatus 22, such as a smart phone. The comparison image capturing apparatus 22 includes, besides the light source 22a and camera 22b, a processor 22c, read-only memory (ROM) 22d, random-access memory (RAM) 22e, inputter 22f, outputter 22g, and communication interface (I/F) 22h.

The processor 22c reads an application program from a memory, such as the ROM 22d or SSD (not illustrated), performs a series of operations using the RAM 22e as a working memory, extracts the ink region from the image captured by the camera 22b, and further clips the comparison image. The processor 22c transmits the clipped comparison image to the server computer 50 via the communication OF 22h. The processor 22c receives comparison results from the server computer 50 via the communication OF 22h. The application program may be downloaded from the server computer 50 or other web server and then installed on the comparison image capturing apparatus 22.

The inputter 22f includes a keyboard, touch switches, and the like and the application program starts when a user operates the inputter 22f.

The outputter 22g functions as a display including a liquid-crystal display or organic electroluminescent (EL) display, and displays a preview when the target 10 is imaged. The outputter 22g also displays a guide image when the target 10 is imaged in response to a control instruction from the processor 22c. The outputter 22g also displays the comparison results received from the server computer 50 in response to a control instruction from the processor 22c. The comparison results are “match” or “mismatch,” but in addition to or in place of the comparison results, a message concerning the comparison may be displayed.

The target 10 serving an imaging target is described below.

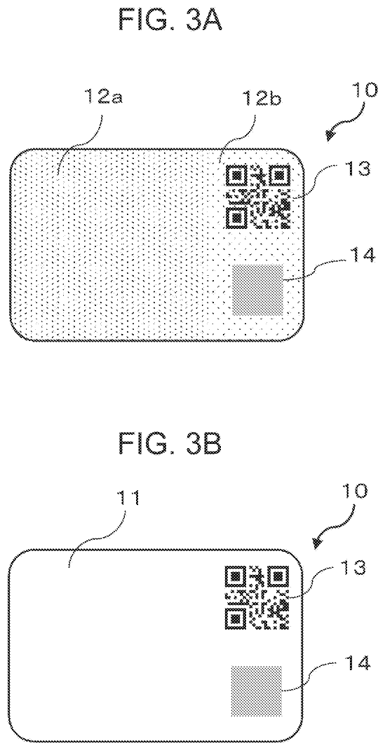

FIGS. 3A and 3B are plan views of the target 10 of the first exemplary embodiment.

Referring to FIG. 3A, a hologram sticker is used as the target 10. The hologram sticker includes hologram regions 12a and 12b, QR code (registered trademark) 13, and ink region 14.

The hologram region 12a includes about a left half of the label sticker and indicates a hologram pattern.

The hologram region 12b includes about a right half of the label sticker and is satin processed. Rainbow-color forming of the hologram region 12b varies in response to an elevation angle. The elevation angle herein refers to an angle made by the light source 22a, target 10, and camera 22b in FIG. 1.

The QR code 13 is formed on the satin-processed hologram region 12b. The QR code 13 printed contains a variety of information on the label sticker. According to the first exemplary embodiment, the QR code 13 may not necessarily be formed.

The ink region 14 is gravure-printed on the hologram region 12b having the satin pattern using gravure ink containing silver particles and has a polygonal shape. Referring to FIGS. 3A and 3B, the ink region 14 has a square shape below the QR code 13 with a gap allowed therebetween. The ink region 14 has a random pattern and is a comparison region that is imaged and extracted by the comparison image capturing apparatus 22. The shape of the ink region 14 may have a polygonal shape or an elliptical shape (including a circular shape).

Referring to FIG. 3B, a paper label sticker is used as the target 10. The paper label sticker includes a paper region 11, QR code 13, and ink region 14.

The ink region 14 is toner-printed on the paper region 11 using toner ink containing silver particles and a polygonal shape. Referring to FIG. 3B, the ink region 14 is printed in a square shape below the QR code 13 with a constant gap allowed therebetween. The ink region 14 is a random pattern area and serves as a comparison region that is imaged and extracted by the comparison image capturing apparatus 22.

As described above, the random pattern of the ink region 14 varies depending on the irradiation direction of light. The irradiation angle y of light from the light source 22a and an angle of the plane are set to be substantially equal to angles serving as a condition that is applied when the registration image is acquired. The term “substantially equal” signifies an allowable range of angle covering a deviation from a specified angle that achieves a comparison accuracy. If the user uses the mobile terminal, such as a smart phone, used as the comparison image capturing apparatus 22, setting the elevation angle and the angle on the plane to specified angles is relatively difficult because of manual setting. It is contemplated that imaging is repeated to obtain an image in better conditions. However, obtaining an image in a better condition for a short period of time may be difficult without a method through which a photographer learns whether these angles are appropriate.

If the mobile terminal, such as a smart phone, is used as the comparison image capturing apparatus 22, there are many models of commercially available smart phones. The layout methods of the light source 22a and the camera 22b may be varied accordingly. Light reflected from the ink region 14 imaged during the comparison is different depending on the different layouts of the camera 22b with respect to the light source 22a, leading to a decrease in comparison accuracy. Even if a variety of commercially available smart phones are used as the comparison image capturing apparatus 22, a certain degree of comparison accuracy may be ensured.

According to the first exemplary embodiment, the target 10 is imaged by dedicated comparison image capturing apparatus 22 and light source 21 mounted at predetermined relative positions to obtain the registration image, and the comparison image is captured using the mobile terminal, such as a smart phone, as the comparison image capturing apparatus 22. Without preparing, for each mobile terminal model, an image resulting from imaging the comparison region at a relative position and posture of a predetermined light source, camera, and comparison region, the predetermined position and posture may be reproduced on each mobile terminal model. To this end, in response to information unique to each mobile terminal model, a guide image is varied and displayed on the display of the mobile terminal, such as a smart phone, as the comparison image capturing apparatus 22.

The user may visually recognize the guide image that varies according to the mobile terminal model, and adjusts the camera pose of the mobile terminal or the posture of the target 10 in accordance with the guide image. The user thus reproduces the predetermined position and posture.

Specifically, the imaging plane of the mobile terminal, such as a smart phone, as the comparison image capturing apparatus 22 and the plane of the ink region 14 are set to be substantially parallel with each other and the ink region 14 of the target 10 is imaged. The processor 22c displays on the display the guide image at an angle of rotation responsive to information related to the relative positional relationship of the camera 22b and light source 22a of the mobile terminal. The guide image is used to image the ink region 14 in a state that the relative position and posture of the light source 22a and camera 22b of the mobile terminal and the ink region 14 satisfy a predetermined relationship.

The information related to the relative positional relationship of the camera 22b and light source 22a includes:
(1) Angle of rotation indicating the direction of the light source 22a on the imaging plane viewed from the camera 22b;
(2) Angle of reflecting surface of the ink region 14;
(3) Distance between the camera 22b and the light source 22a;
(4) Distance between the ink region 14 and the camera 22b in the direction of the plane of the ink region 14; and
(5) Distance between the imaging plane of the mobile terminal and the plane of the ink region 14.

Basic information out of these pieces of information is (1) Angle of rotation indicating the direction of the light source 22a on the imaging plane viewed from the camera 22b. If the angle of rotation is different from the angle of rotation during the registration, more precisely, an angular difference between the two angles of rotation is not within an allowable range of angle (for example, ±15°), comparison is disabled. The user may easily adjust the angle of rotation by rotating the mobile terminal or the target 10.

The angle of rotation is described below.

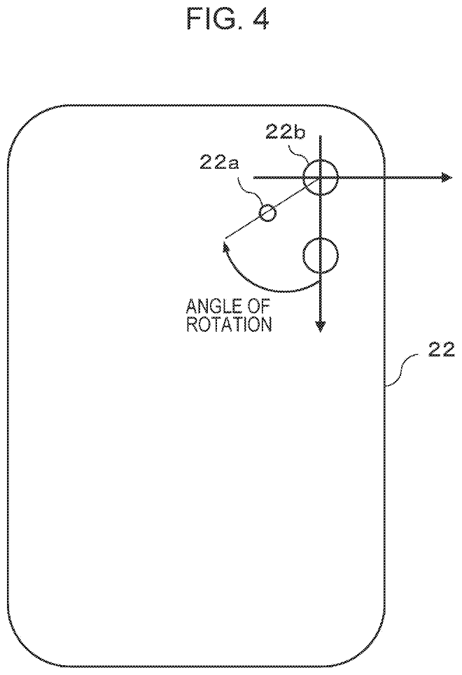

FIG. 4 is a plan view illustrating a positional relationship between the light source 22a and the camera 22b on the imaging plane. The two cameras 22b are arranged in a longitudinal direction of the mobile terminal with a predetermined space therebetween (the longitudinal direction is a vertical direction in FIG. 4). For convenience of explanation, the upper camera 22b of the two cameras is used to image the ink region 14. The angle of rotation is defined as the direction of the light source 22a viewed from the upper camera 22b with respect to the longitudinal direction of the mobile terminal.

The angle of rotation may be different depending on the model of the mobile terminal. The angle of rotation of the guide image displayed on the display is adjusted in view of the angle of rotation of the corresponding model such that the angle of rotation on the imaging plane during the registration, namely, the angle of rotation between the light source 21 and the registration image capturing apparatus 20 is reproduced.

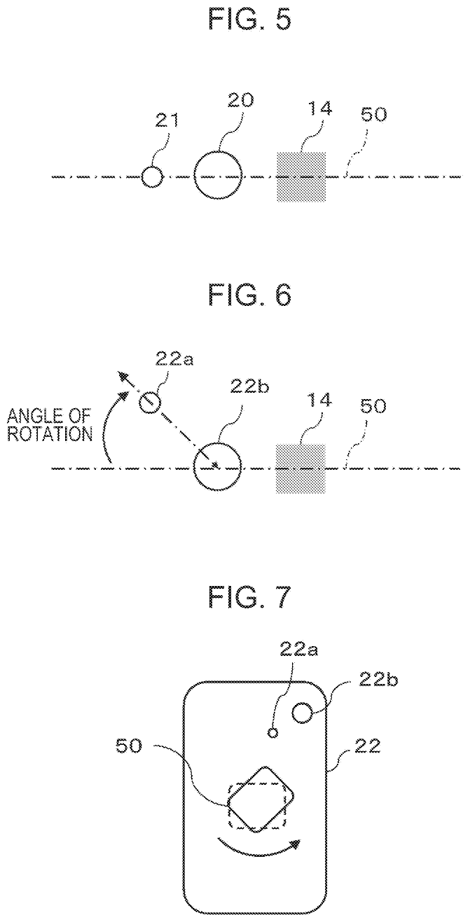

FIG. 5 illustrates an example of the positional relationship of the light source 21, camera 20, and ink region 14 during the registration. The light source 21, camera 20, and ink region 14 are aligned in a straight line 50. In this case, the direction of the light source 21 with respect to the camera 20, namely, the angle of rotation is 0°. In order to reproduce the relative position and posture of the predetermined the light source 21, camera 20, and ink region 14 during the comparison image capturing time, the angle of rotation is set to 0° or within the allowable range of angle (for example, ±15°).

FIG. 6 illustrates an example of the positional relationship of the light source 22a and the camera 22b of the mobile terminal, such as a smart phone, used as the comparison image capturing apparatus 22, and the ink region 14. The positional relationship of the light source 22a and camera 22b is different depending on the model of the mobile terminal. If a constant angle of rotation is presumed, the angle of rotation is different from the angle of rotation during the registration (namely, 0°).

If the user has knowledge about the angle of rotation during the registration, he or she may photograph with the knowledge. However, the user typically has no knowledge about the angle of rotation and may use a guideline for adjusting the angle of rotation.

Referring to FIG. 7, the user may be prompted to rotate the comparison image capturing apparatus 22 or the target 10 such that the angle of rotation matches the angle of rotation during the registration (0°) within the allowable range of angle. When a preview image is displayed on the display of the comparison image capturing apparatus 22, a guide image 50 imitating the target 10 is displayed and rotated in superimposition on the preview image.

The processor 22c displays on the display the guide image using information on the angle of rotation of the light source 22a viewed from the camera 22b of the mobile terminal of interest and the information on the angle of rotation of the mobile terminal of interest may be retrieved from the server computer 50 prior to capturing the comparison image. The information on the angles of rotation on each mobile terminal model, such as a smart phone, used as the comparison image capturing apparatus 22 is stored in advance on the server computer 50 and in response to a request from the comparison image capturing apparatus 22, the information on the angles of rotation responsive to the model of the comparison image capturing apparatus 22 is transmitted to the processor 22c in response. When an application program is installed on the comparison image capturing apparatus 22, the information on the angles of rotation on the mobile terminal of interest or all the mobile terminals may be downloaded from the server computer 50. If the information on the angles of rotation on all models of mobile terminals is downloaded, the processor 22c selects the information on the angles of rotation on the mobile terminal of interest and causes the corresponding guide image to be displayed.

If the information on the angles of rotation on the model of the mobile terminal of the interest is retrieved from the server computer 50, the processor 22c may retrieve the model name of the mobile terminal of interest from the ROM 22d. Alternatively, when a comparison program is installed, the user may manually enter and set the name of the model of the mobile terminal of interest.

A display form of the guide image 50 is specifically described.

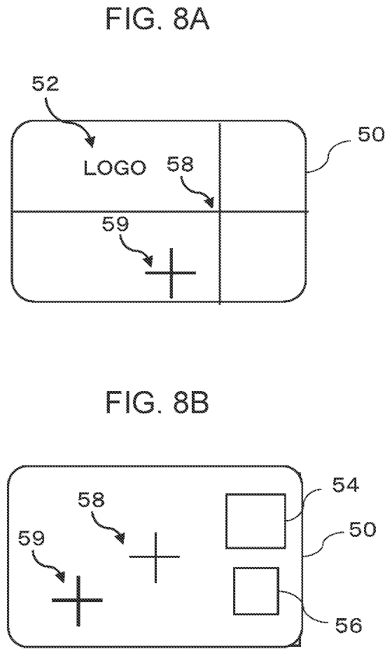

FIGS. 8A and 8B illustrate examples of the guide image 50 on the preview image displayed on the display of the comparison image capturing apparatus 22 prior to the rotation, namely, when the angle of rotation is not accounted for.

The guide image 50 imitates an external shape of the target 10, the QR code 13 formed on the target 10, and a shape of the ink region 14 (see FIGS. 3A and 3B). If the target 10 contains characters (logo) 52, the characters 52 may be displayed on the guide image 50 as illustrated in FIG. 8A and the direction of the characters 52 may define the top and bottom of the target 10.

Referring to FIG. 8B, the top and bottom may be defined by displaying squares 54 and 56 respectively representing the QR code 13 and ink region 14 on the guide image 50. Moreover, a cross symbol 58 is displayed at a predetermined position, for example, at the center of the guide image 50, and a drawing 59 that serves as a status guide indicating the status of the posture of the mobile terminal is displayed and moved in response to the parallelism of the mobile terminal and the label sticker. The drawing 59 is displayed in superimposition on the drawing 58 when the mobile terminal is in parallel with the label sticker. The drawing 59 thus functions as a guide indicating the parallelism of the imaging plane and the plane of the ink region 14. A status guide indicating a status other than parallelism may be displayed. For example, shape images indicating the shape of the label sticker, rectangle of the logo, rectangle of the ink region, and QR code may be displayed. In response to a recognized position of each of the shape images, indicating the shape of the label sticker, rectangle of the logo, rectangle of the ink region, and QR code, on an imaging screen, the shape image may function as a status guide. By changing the guide in color or by associating the guide with a message, the status guide may work indicating whether a predetermined position is correctly recognized or not. A message indicating a screen blur, stain, or brightness of the ink region or reflection of outside light on the ink region may be displayed to function as the status guide. The displaying of the status guide is not particularly limited to any timing. For example, the status guide may be displayed when the preview image is acquired and analyzed or when the captured image is analyzed. The status guide, when displayed, lets an operator recognize the status of the posture of the present mobile terminal and the operator may adjust the posture such that the status guide is aligned with a fixed guide that indicates a specified posture displayed at the predetermined position. The adjustment operation may thus be efficiently performed. The display form of the status guide may be listed as below.
Displayed in shape (for example, a dynamic guide varying in size in response to an actual target)
Displayed in color (for example, color changing in appropriate status)
Displayed by characters (for example, a message reading “Size mismatch”)
Displayed in drawing (for example, an arrow mark indicating the direction of movement)

These guide images 50 are displayed in an upright position on the display of the mobile terminal before the rotation.

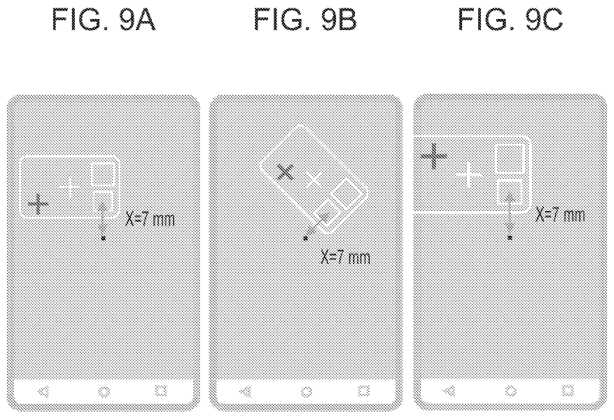

FIGS. 9A through 9C illustrate the guide images 50 respectively displayed in superimposition on the preview image on the display on the models of mobile terminal. FIG. 9A illustrates the guide image 50 for model A, FIG. 9B illustrates the guide image 50 for model B, and FIG. 9C illustrates the guide image 50 for model C.

The angle of rotation, distance L, imaging resolution (distance D=100 mm), and size ratio of (preview image of the display)/(captured image) of each of the models A, B, and C are listed below.

### Model A:

Angle of rotation=0°
Distance L=30 mm
Imaging resolution=850 dpi
Size ratio=0.36

### Model B:

Angle of rotation=45°
Distance L=10 mm
Imaging resolution=850 dpi
Size ratio=0.36

### Model C:

Angle of rotation=0°
Distance L=30 mm
Imaging resolution=850 dpi
Size ratio=0.45
   It is noted that the angle of rotation and distance L are different from model to model. The imaging resolution may be different from model to model, but herein the imaging resolution is unified to 850 dpi.

The angle of rotation of the guide image 50 varies in response to a difference between the models A, B, and C as illustrated in FIGS. 9A, 9B, and 9C. Since the angle of rotation is 0° in the model A, the guide image 50 is displayed in the upright position.

Since the angle of rotation is 45° in the model B, the guide image 50 rotated by 45° from the upright position is displayed.

Since the angle of rotation is 0° in the model C, the guide image 50 is displayed in the upright position.

The distance X is 7 mm as an optimum value in all models. The distance X is a distance between the center of the preview image on the display and the center of the ink region 14.

A guide width of the guide image 50 is calculated in accordance with ((actual width W of the target 10)/25.4)×(specified imaging resolution)×(size ratio). Since the models A and B have the same size ratio of 0.36, the models A and B also have the same guide width of the guide image 50. Since the model C has a greater size ratio, namely, 0.45, the guide image 50 having a larger guide width is displayed.

If the target 10 is imaged using the model A, the user images the target 10 in the upright position in alignment with the guide image 50. On the other hand, if the target 10 is imaged using the model B, the guide image 50 is displayed as being rotated on the preview image. The user images the target 10 in a posture in which the model B or the guide image 50 is rotated.

Referring to FIGS. 9A, 9B, and 9C, the guide image 50 is rotated and displayed in response to the angle of rotation of the model. Alternatively, the guide image 50 is displayed in the upright position and the direction of rotation and the magnitude of angle responsive to the angle of rotation of the model may be displayed by characters. For example, “Rotate a target image by 30 degrees from the upright position.” In other words, the guide image 50 is not limited to drawings and may be a combination of a drawing and characters or only characters. The drawings may include an arrow mark indicating the direction of rotation.

The entire process of the first exemplary embodiment is described below. The entire process includes a process in which the comparison image capturing apparatus 22 captures the comparison image and a process in which the comparison image is compared with the registration image.

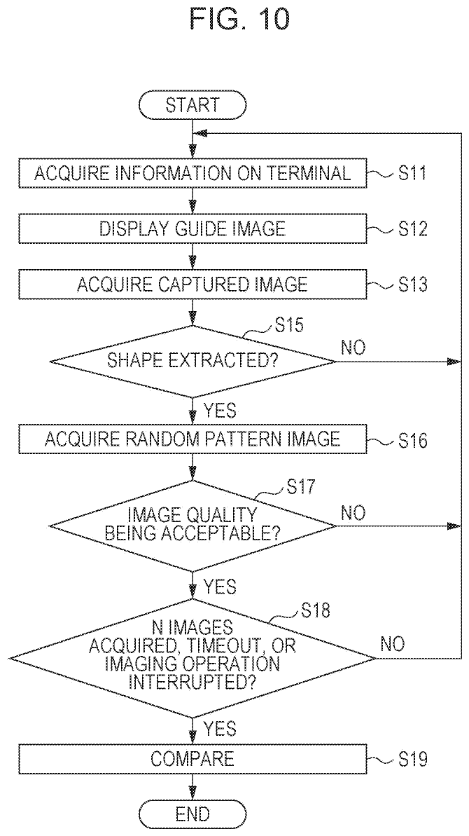

FIG. 10 illustrates a flowchart of the process of the processor 22c. The process is performed when an application program read from the ROM 22d or the like is executed.

The processor 22c accesses the server computer 50 and acquires information on the mobile terminal (S11). For example, the processor 22c requests information on the mobile terminal by transmitting the model name of the mobile terminal to the server computer 50 and the server computer 50 transmits in reply to the processor 22c information responsive to the model name. Specifically, the information responsive to the model name includes: Information on the angle of rotation of the light source 22a viewed from the camera 22b; Information on distance L between the light source 22a and the camera 22b; and Information on the imaging resolution

If the mobile terminal is the model B, the server computer 50 transmits in reply information on the model A. The information on the model A includes:
Angle of rotation=45°;
Distance L=10 mm; and
Imaging resolution=900 dpi.

The processor 22c produces the guide image 50 using the acquired information on the angle of rotation and displays the guide image 50 in superimposition on the preview image (S12). When the guide image 50 drawn on a transparent object having the same size as the display is displayed on the display, the processor 22c draws the transparent object with the guide image rotated from the upright position in response to the angle of rotation and then displays the guide image and the transparent object on the display.

Information related to the design of the target 10 used to produce the guide image 50 may be stored on a memory of the mobile terminal, may be entered as a basic parameter in the application program, or may be acquired from the server computer 50. Specifically, the information related to the design of the target 10 includes:
Length of one side of the ink region 14 (mm);
Length of one side of the QR code 13;
Width of the target 10 (mm); and
Height of the target 10 (mm).
   The position of the guide image 50 is defined with respect to the top left corner of the guide image 50 serving as the origin.

The processor 22c may determine as appropriate whether the imaging plane of the light source 22a and camera 22b is substantially in parallel with the plane of the ink region 14. The determination may be performed in response to a sensor signal from a gyro sensor or using the position of a luminance point in the image or a color forming pattern of the hologram region 12b. If the imaging plane of the light source 22a and camera 22b is not substantially in parallel with the plane of the target 10, the processor 22c displays an appropriate message on the display to prompt the user to cause the planes to be parallel with each other.

The determination process to determine the parallelism (parallelism determination) may be skipped. Instead of performing the parallelism determination, a determination may be performed to determine whether a predetermined label rectangular shape, log design, ink patch rectangle, or QR code 13 is included in the captured image. If the parallelism determination is not performed, the display position of the drawing 59 (see FIGS. 8A and 8B) that moves in response to the parallelism may be updated appropriately (for example, every 100 ms) or the results of the parallelism determination may be displayed. The user may thus recognize the current status of parallelism and operate the adjustment process more efficiently. The processor 22c acquires the image captured by the camera 22b at the posture obtained by the guide image 50 (S13).

The guide image 50 is thus displayed on the display, the camera pose during the comparison is determined, and the image of the ink region 14 is captured by the camera 22b. The shape of the ink region 14 (more precisely, a square) is extracted from the captured image (S15). The shape of the ink region 14 may be extracted by acquiring four vertexes forming the square of the ink region 14. The method of acquiring the coordinates of the four vertexes may be optional. For example, the coordinates of the four vertexes may be acquired through three processes including image thresholding, rectangular edge extraction, and vertex coordinate estimation process.

When the coordinates of the four vertexes of the ink region 14 are extracted (yes path in S15), the processor 22c acquires a random pattern image by clipping the comparison image according to the four vertexes (S16). The processor 22c then evaluates the random pattern image, in other words, determines whether the quality of the random pattern image is acceptable (S17).

The determination as to whether the quality of the random pattern image is acceptable is performed by evaluating the following indexes, in other words, whether these indexes exceed thresholds thereof. The indexes include:
(1) Whether the position, size, and angle of the square are appropriate;
(2) Degree of blur (standard deviation of Laplacian filter values);
(3) Degree of camera shake (difference between maximum and minimum of standard deviations of Sobel filter values in four directions);
(4) Brightness (mean luminance value);
(5) Randomness (center portion of the image as large as ¼ the size of the image is clipped, a correlation value between each coordinate of the image and an image having the same size and serving as a start point is determined, the maximum value of the correlation values is subtracted by the mean value of the correlation values, and the randomness is obtained by dividing the resulting difference by the standard deviation of the correlation values); and (6) Deviation of the light source (aspect ratio of the gradient of luminance of the image=(gradient resulting from linear-approximating luminance average values on the same row in the direction of column)/(gradient resulting from linear-approximating luminance average values on the same column in the direction of row).

Whether the image quality is acceptable may be determined by referring to one of the indexes or a combination of any indexes. For example, the combination of indexes (1) and (6) or the combination of indexes (1), (5), and (6) may be used.

Operations in S11 through S17 are iterated until a predetermined upper limit number N of images are obtained, until timeout, or until the user stops an image capturing operation (S18). A comparison process is thus performed using N random pattern images or random pattern images obtained until the timeout or until the stop of the image capturing operation (S19).

In the comparison process, a comparison request together with the upper limit number N of random pattern images or multiple number of random pattern images is transmitted to the server computer 50. The comparator 50a in the server computer 50 compares the received random pattern images with the registration image and transmits in reply the comparison results to the comparison image capturing apparatus 22. The processor 22c receives the comparison results from the server computer 50 and displays the comparison results on the outputter 22g.

According to the first exemplary embodiment, the guide image 50 is rotated by the angle of rotation that varies in accordance with the model of the mobile terminal, such as a smart phone, used as the comparison image capturing apparatus 22 and is displayed on the display. The predetermined relative position and posture are thus reproduced.

### Second Exemplary Embodiment

According to the first exemplary embodiment, the guide image 50 is rotated and displayed such that the angle of rotation as the direction of the light source 22a viewed from the camera 22b is caused to match the angle of rotation during the registration. The processor 22c may adjust the position of the guide image in accordance with the distance X between the ink region 14 and the camera 22b in the plane direction of the ink region 14 and then display the guide image.

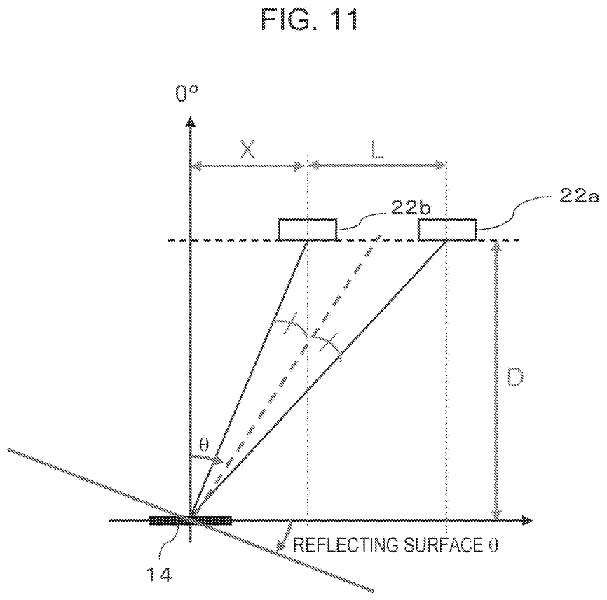

FIG. 11 illustrates the positional relationship of the light source 22a, camera 22b, and ink region 14.

Based on the assumption that the imaging plane of the mobile terminal serving as the comparison image capturing apparatus 22 is parallel with the plane of the ink region 14, related parameters are defined as below:
θ: Angle of reflecting surface of the ink region 14;
L: Distance between the light source 22a and camera 22b;
X: Distance between the ink region 14 and camera 22b; and
D: Distance between the imaging surface and the plane of the ink region 14.
   The angle of the reflecting surface is defined as the angle of the normal line to the middle of the angle made by the light source 22a, ink region 14, and camera 22b. The following relationship holds among the parameters:

$$θ = \frac{1}{2} \{ arc tan ( \frac{X}{D} ) + arc tan ( \frac{X + L}{D} ) \} = \frac{1}{2} arc tan ( \frac{D ( 2 X + L )}{{D}^{2} - X ( X + L )} ) \qquad Equation ( 1 )$$

If Equation (1) is deformed, Equation (2) results:

$$X = \frac{- ( L tan 2 θ + 2 D ) \pm \sqrt{{( L tan 2 θ + 2 D )}^{2} - 4 ( DL - {D}^{2} tan 2 θ )} tan 2 θ}{2 tan 2 θ} . \qquad Equation ( 2 )$$

The reflecting surface angle θ of the ink region 14 is to match the reflecting surface angle during the registration (within the allowable range of angle). According to the Equations, the reflecting surface angle θ is determined in accordance with the distance X between the ink region 14 and the camera 22b, the distance D between the imaging plane and the plane of the ink region 14, and the distance L between the light source 22a and camera 22b.

The inventors have found that the reflecting surface angle θ is affected more by a variation in the distance D than a variation in the distance X, within a tolerance of the distance L of the mobile terminals, such as currently commercially available smart phones.

Table 1 lists a relationship between the distance D (mm) of models of mobile terminal, such as a smart phone, used as the comparison image capturing apparatus 22 and a specified imaging resolution (dpi). The models listed are models A, B, C, and D, and the specified imaging resolutions are 700 dpi, 750 dpi, 800 dpi, 850 dpi, and 900 dpi.

TABLE 1

| | Model A | Model B | Model C | Model D |
|---|---|---|---|---|
| 700 dpi | 129 | 125 | 122 | 112 |
| 750 dpi | 123 | 118 | 115 | 106 |
| 800 dpi | 117 | 111 | 108 | 99 |
| 850 dpi | 110 | 109 | 100 | 92 |
| 900 dpi | 104 | 97 | 93 | 85 |

If the imaging resolution is fixed to 800 dpi, the distance D varies within a range of 99 mm to 117 mm because the angle of view is different from model to model. In other words, the distance D has an error as high as about 20 mm (ΔD=20 mm).

Table 2 lists the relationship of the distance X, distance L, distance D and reflecting surface angle 0 of the ink region 14.

Distances X (mm) listed are 2, 7, 12, and the distances L (mm) listed are 10, 25, 40, and distances D (mm) listed are 80, 90, 100, 110, 120, and 130.

TABLE 2

| X | 2 | 2 | 2 | 7 | 7 | 7 | 12 | 12 | 12 |
|---|---|---|---|---|---|---|---|---|---|
| L | 10.0 | 2.5 | 40 | 10 | 25 | 40 | 10 | 25 | 40 |
| 80 | 5.0 | 10.0 | 14.6 | 8.5 | 13.4 | 17.7 | 12.0 | 16.7 | 20.8 |
| 90 | 4.4 | 9.0 | 13.1 | 7.6 | 12.0 | 16.0 | 10.7 | 16.0 | 18.8 |
| 100 | 4.0 | 8.1 | 12.0 | 6.8 | 10.9 | 14.6 | 9.6 | 13.6 | 17.2 |
| 110 | 3.6 | 7.4 | 11.0 | 6.2 | 9.9 | 13.4 | 8.8 | 12.4 | 15.8 |
| 120 | 3.3 | 6.8 | 10.1 | 5.7 | 9.1 | 12.4 | 8.0 | 11.4 | 14.6 |
| 130 | 3.1 | 6.3 | 9.4 | 5.3 | 8.5 | 11.5 | 7.4 | 10.6 | 13.5 |

If the distance X=7 mm and the distance L=40 mm, the following values result:
Reflecting surface angle θ=17.7° at D=80 mm,
Reflecting surface angle θ=16.0° at D=90 mm,
Reflecting surface angle θ=14.6° at D=100 mm,
Reflecting surface angle θ=13.4° at D=110 mm,
Reflecting surface angle θ=12.4° at D=120 mm, and
Reflecting surface angle θ=11.5° at D=130 mm.

If the distance L is fixed to L=40 mm, the following values result:
Reflecting surface angle θ=14.6° at D=100 mm, and
Reflecting surface angle θ=12.4° at D=120 mm.
   If the distance D is fixed (with a variation as large as about 20 mm allowed for the distance D), the reflecting surface angle θ has a variation of about 3° responsive to the variation of the distance D.

If the distance X is fixed to X=7 mm, the following values result:
Reflecting surface angle θ=6.8° at L=10 mm, and
Reflecting surface angle θ=14.6° at L=40 mm.
   The reflecting surface angle θ has a variation of about 8° responsive to the variation of the distance L.

The reflecting surface angle θ is affected by the distance X more than by the distance D and an error in the reflecting surface angle θ may be more controlled by the optimization of the distance X for a variety of models than by the optimization of the distance D for the variety of models.

The processor 22c optimizes the distance X such that an optimum reflecting surface angle θ is obtained and displays the guide image 50 on the display by adjusting the position of the guide image 50 such that the optimum reflecting surface angle θ results.

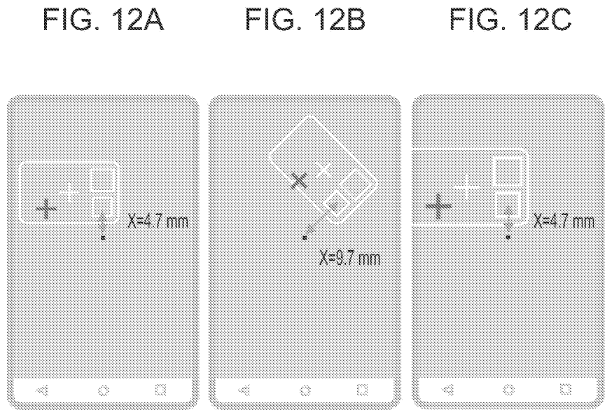

FIGS. 12A through 12C illustrate examples of the guide image 50 that are displayed on the display of the comparison image capturing apparatus 22 when not only the angle of rotation but also the distance X are accounted for. FIG. 12A illustrates the guide image 50 of the model A, FIG. 12B illustrates the guide image 50 of the model B, and FIG. 12C illustrates the guide image 50 of the model C.

The angle of rotation, distance L, imaging resolution (distance D=100 mm) and size ratio of (preview image of the display)/(captured image) remain unchanged from those of the first exemplary embodiment.

The optimum distance X varies in response to a difference of the distance L depending on the model. Specifically, the distances X of the models are listed as follows;

### Model A

Distance X=4.7 mm,

### Model B

Distance X=9.7 mm, and

### Model C

Distance X=4.7 mm.
   These distances are displayed as a difference in the position of the guide image 50 on the display. The position of the guide image is displayed by the distance between the center of the display (the center of the preview image) and the center of the ink region 14.

According to the first exemplary embodiment, the distance X is unified to X=7 mm in all the models, namely, models A, B, and C.

In contrast, according to the second exemplary embodiment, with the distance X=4.7 mm in the model A, the guide image 50 is displayed closer to the center of the preview image than in the first exemplary embodiment.

With the distance X=9.7 mm in the model B, the guide image 50 is displayed farther from the center of the preview image than in the first exemplary embodiment. With the distance X=4.7 mm in the model C, the guide image 50 is displayed closer to the center of the preview image than in the first exemplary embodiment.

### Third Exemplary Embodiment

According to the first exemplary embodiment, the guide image 50 is rotated and displayed in response to the angle of rotation of the light source 22a viewed from the camera 22b. According to the second exemplary embodiment, in addition to the rotation of the guide image 50 in the first exemplary embodiment, the guide image 50 is displayed at the position responsive to the distance X. Furthermore, the displayed guide image 50 may be adjusted in size in response to the imaging resolution of each model at the distance D.

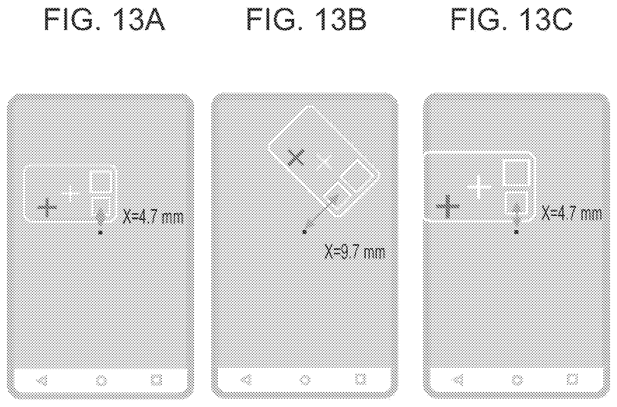

FIGS. 13A through 13C illustrate examples of the guide image 50 displayed on the display of the comparison image capturing apparatus 22 when the imaging resolution of each model at the distance D and a difference in the angle of view and pixel size of the captured image of the camera on each model are accounted for in addition to the angle of rotation and the distance X. FIG. 13A illustrates the guide image 50 of the model A, FIG. 13B illustrates the guide image 50 of the model B, and FIG. 13C illustrates the guide image 50 of the model C.

The values of the angle of rotation, distance L, imaging resolution (distance D=100 mm), and size ratio of (preview of the display)/(captured image) are identical to those of the first and second exemplary embodiments.

The imaging resolution at the distance D further depends on performance of the camera and is listed as follows:

### Model A:

Imaging resolution=800 dpi,

### Model B:

Imaging resolution=900 dpi, and

### Model C:

Imaging resolution=800 dpi.

The imaging target on the preview image is different in size depending on a difference in the imaging resolution. Specifically, the guide image 50 varies in size from model to model.

The imaging resolution at the distance D is determined from the angle of view of the camera and the pixel size (3000×4000 px as digital data) of the captured image, which are information on camera performance not dependent on the distance D. The imaging resolution at the distance D is determined from the information on the camera performance as described below.

The imaging resolution [dpi] at the distance D=(pixel size [px] of the captured image)÷(actual size of the image captured at the distance D [inch])=(pixel size [px] of the captured image)÷(2*D [mm]*tan (angle of view [rad]÷2)÷25.4 [mm/inch])

With the imaging resolution fixed to 850 dpi, the guide width of the guide image 50 in the first exemplary embodiment (the second exemplary embodiment as well) is as follows:

### Models A and B:

W×850/25.4×0.36, and

### Model C

W×850/25.4×0.45.
   Since the imaging resolution is different from model to mode in the third exemplary embodiment, the guide width of each model is as follows:

### Model A:

W×800/25.4×036,

### Model B:

W×900/25.4×0.36, and

### Model C:

W×800/25.4×0.45.

The guide image 50 of the model A in the third exemplary embodiment illustrated in FIG. 13A is smaller in size than the guide image 50 in the second exemplary embodiment illustrated in FIG. 12A by 800/850.

The guide image 50 of the model B in the third exemplary embodiment illustrated in FIG. 13B is larger in size than the guide image 50 in the second exemplary embodiment illustrated in FIG. 12B by 900/850.

The guide image 50 of the model C in the third exemplary embodiment illustrated in FIG. 13C is smaller in size than the guide image 50 in the second exemplary embodiment illustrated in FIG. 12C by 800/850.

### Modifications

According to the first through third exemplary embodiments, dedicated instruments are used as the registration image capturing apparatus 20 and light source 21. As described above, the registration image capturing apparatus 20 and light source 21 may be a mobile terminal, such as a smart phone, used as the comparison image capturing apparatus 22.

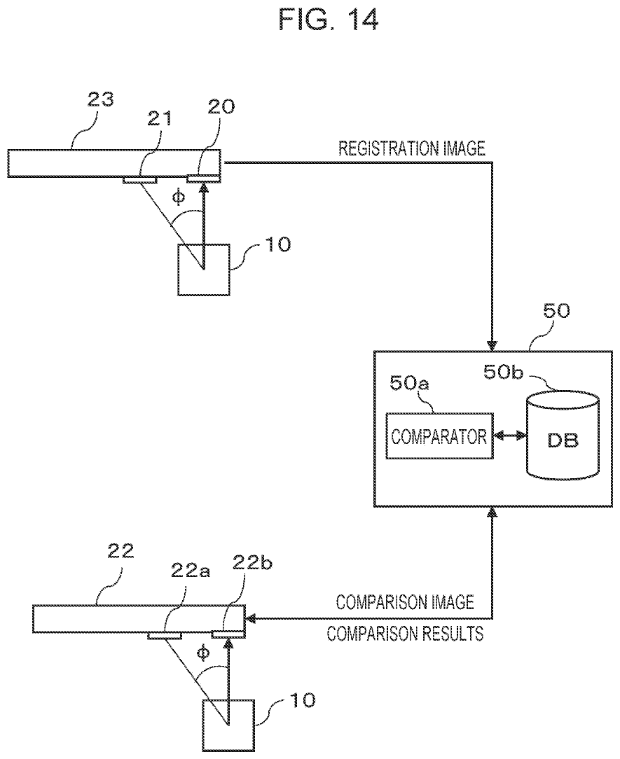

FIG. 14 illustrates a system configuration of a modification of the exemplary embodiments. The system configuration illustrated in FIG. 14 is different from the system configuration illustrated in FIG. 1 in that the registration image capturing apparatus 20 and light source 21 is a mobile terminal 23 that is a smart phone as the comparison image capturing apparatus 22.

In this case, the mobile terminal 23 having captured the registration image and the mobile terminal as the comparison image capturing apparatus 22 may or may not be the same model. If the two mobile terminals are different in model, the guide image 50 may be displayed such that the angle of rotation the light source 21 viewed from the registration image capturing apparatus 20 in the mobile terminal 23 capturing the registration image is caused to match the angle of rotation of the light source 22a viewed from the camera 22b capturing the comparison image.

Specifically, a reference angle of rotation serving as a reference is determined in advance, the guide image 50 is displayed on the display of the mobile terminal 23 capturing the registration image such that the guide image 50 aligns the reference angle of rotation in response to the angle of rotation of the mobile terminal. The registration image is captured in accordance with the guide image 50. The registration image functions as a “correct image” during the comparison.

The guide image 50 is displayed on the display of the mobile terminal capturing the comparison image such that the guide image 50 aligns the reference angle of rotation in response to the angle of rotation of the mobile terminal. The comparison image may be captured in accordance with the guide image 50. The server computer 50 compares the registration image (correct image) with the comparison image and transmits comparison results to the mobile terminal as the comparison image capturing apparatus 22.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A mobile terminal including:
a light source;
a camera;
a display; and
a processor configured to:
   when a comparison region of a target is imaged, display on the display a guide image at an angle of rotation responsive to information related to a positional relationship of the camera and the light source, the guide image being used to image the comparison region, with a relative position and posture of the light source, the camera, and the comparison region satisfying a specific relationship.
      (((2)))

In the mobile terminal according to (((1))), the processor is further configured to display on the display the guide image at a position responsive to information related to a distance between the camera and the light source.

(((3)))

In the mobile terminal according to (((2))), the position is set in accordance with a distance between a center of the display and a center of the comparison region displayed in the guide image.

(((4)))

In the mobile terminal according to one of (((1))) through (((3))), the processor is further configured to display on the display the guide image in a size responsive to information related to performance of the camera.

(((5)))

In the mobile terminal according to (((4))), the information related to the performance of the camera is related to an angle of view of the camera and an image pixel size of the camera.

(((6)))

In the mobile terminal according to one of (((1))) through (((5))), the processor is further configured to display on the display the guide image in a size responsive to information on an imaging resolution of the camera at a distance between a predetermined target and the camera.

(((7)))

An imaging method of a mobile terminal including a light source, a camera, and display and imaging a comparison region, the imaging method including:
when a comparison region of a target is imaged, displaying on the display a guide image at an angle of rotation responsive to information related to a positional relationship of the camera and the light source, the guide image being used to image the comparison region, with a relative position and posture of the light source, the camera, and the comparison region satisfying a specific relationship.
   (((8)))

A program causing a processor in a mobile terminal including a light source, a camera, and a display to execute a process, the process including:
when a comparison region of a target is imaged, displaying on the display a guide image at an angle of rotation responsive to information related to a positional relationship of the camera and the light source, the guide image being used to image the comparison region, with a relative position and posture of the light source, the camera, and the comparison region satisfying a specific relationship.
   (((9)))

In the program according to (((8))), the processor is further caused to display on the display the guide image at a position responsive to information related to a distance between the camera and the light source.

(((10)))

In the program according to (((8))), the position is set in accordance with a distance between a center of the display and a center of the comparison region displayed in the guide image.

(((11)))

In the program according to one of (((8))) through (((10))), the processor is further caused to display on the display the guide image in a size responsive to information related to performance of the camera.

(((12)))

In the program according to (((11))), the information related to the performance of the camera is related to an angle of view of the camera and an image pixel size of the camera.

(((13)))

In the program according to one of (((8))) through (((12))), the processor is further caused to display on the display the guide image in a size responsive to information on an imaging resolution of the camera at a distance between a predetermined target and the camera.

What is claimed is:

1. A mobile terminal comprising:
a light source;
a camera;
a display; and
a processor configured to:
when a comparison region of a target is imaged, display on the display a guide image at an angle of rotation responsive to information related to a positional relationship of the camera and the light source, the guide image being used to image the comparison region, with a relative position and posture of the light source, the camera, and the comparison region satisfying a specific relationship.

2. The mobile terminal according to claim 1, wherein the processor is configured to display on the display the guide image at a position responsive to information related to a distance between the camera and the light source.

3. The mobile terminal according to claim 2, wherein the position is set in accordance with a distance between a center of the display and a center of the comparison region displayed in the guide image.

4. The mobile terminal according to claim 2, wherein the processor is configured to display on the display the guide image in a size responsive to information related to performance of the camera.

5. The mobile terminal according to claim 4, wherein the information related to the performance of the camera is related to an angle of view of the camera and an image pixel size of the camera.

6. The mobile terminal according to claim 2, wherein the processor is configured to display on the display the guide image in a size responsive to information on an imaging resolution of the camera at a distance between a predetermined target and the camera.

7. An imaging method of a mobile terminal including a light source, a camera, and display and imaging a comparison region, the imaging method comprising:
when a comparison region of a target is imaged, displaying on the display a guide image at an angle of rotation responsive to information related to a positional relationship of the camera and the light source, the guide image being used to image the comparison region, with a relative position and posture of the light source, the camera, and the comparison region satisfying a specific relationship.

8. A non-transitory computer readable medium storing a program causing a computer in a mobile terminal including a light source, a camera, and a display to execute a process, the process comprising:
when a comparison region of a target is imaged, displaying on the display a guide image at an angle of rotation responsive to information related to a positional relationship of the camera and the light source, the guide image being used to image the comparison region, with a relative position and posture of the light source, the camera, and the comparison region satisfying a specific relationship.

9. The non-transitory computer readable medium according to claim 8, wherein the process further comprises displaying on the display the guide image at a position responsive to information related to a distance between the camera and the light source.

10. The non-transitory computer readable medium according to claim 8, wherein the position is set in accordance with a distance between a center of the display and a center of the comparison region displayed in the guide image.

11. The non-transitory computer readable medium according to claim 8, wherein the process further comprises displaying on the display the guide image in a size responsive to information related to performance of the camera.

12. The non-transitory computer readable medium according to claim 11, wherein the information related to the performance of the camera is related to an angle of view of the camera and an image pixel size of the camera.
